(19) United States
(12) Patent Application Publication
(10) Pub. No.: US 2015/0235510 A1
(43) Pub. Date: Aug. 20, 2015

(54) ELECTRONIC GAMING MACHINE AND GAMING METHOD

(71) Applicant: Ainsworth Game Technology Limited, Newington (AU)

(72) Inventor: Jason Meyer, Abbotsford (AU)

(21) Appl. No.: 14/627,604

(22) Filed: Feb. 20, 2015

(30) Foreign Application Priority Data
Feb. 20, 2014 (AU) 2014900542

(51) Int. Cl. G07F 17/32; G07F 17/34

(52) U.S. Cl. CPC G07F 17/3213; G07F 17/34

(57) ABSTRACT

The invention provides an electronic gaming machine comprising an electronic game controller and a display for displaying a game. The game comprises predetermined winning combinations of randomly selected game symbols in the game award prizes to a player. The game symbols are arranged into an array of groups of one or more predetermined game positions. In response to a trigger event occurring in a play of the game, the electronic game controller permits the player to select one or more of the groups. After this selection, the electronic game controller transmits a signal to the display so that the selected groups randomly display one or more special symbols in one or more subsequent plays of the game so as to increase the probability of the electronic gaming machine displaying one of the predetermined winning combinations and/or award a game enhancing element upon the player.

### BACKGROUND

The present invention relates to an electronic gaming machine and in a particular an electronic gaming machine having a base game and a feature game. The invention has been developed primarily for use as an electronic gaming machine and will be described hereinafter by reference to this application

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, computational processor or other central processing unit, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. This means that the feature game is restricted by the same set of rules, and so there is no variation in the play of the feature game. Consequently, it is difficult to retain player interest because there is no apparent incentive for the player to continue playing the same electronic gaming machine once the player becomes familiar with the feature game and the main game. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

It is an object of the invention in at least one preferred form to provide an electronic gaming machine and a gaming method for an electronic gaming machine that encourages player interest.

### SUMMARY

According to a first aspect of the present invention, there is provided an electronic gaming machine comprising:

a display for displaying a game, wherein said game comprises game symbols arranged into an array of groups of predetermined game positions displaying randomly selected game symbols, and where predetermined winning combinations of said randomly selected game symbols in said game award prizes to a player, and

an electronic game controller for controlling the display of game symbols for said game on said display,

wherein in response to a trigger event occurring in a play of said game, said electronic game controller permits the player to select one or more of said groups of predetermined game positions and after said selection said electronic game controller causes said selected groups to randomly display one or more special symbols in one or more subsequent plays of said game so as to increase the probability of the electronic gaming machine displaying one of said predetermined winning combinations and/or award a game enhancing element upon the player.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Preferably, the groups selected by the player determine the number of said subsequent plays of said game.

Preferably, the groups selected by the player determine the type of special symbols displayed in said groups. More preferably, said special symbols comprise at least one or more of symbols that award a predetermined number of free games, a win multiplier symbol, wild multiplier symbol, bonus wild symbols, symbols that cause the award of additional free games, symbols that cause reels to be held static and display wild symbols, random wild symbols, stacked symbols, bonus symbols, new game symbols, reveal symbols, progressive jackpot symbols, symbols that award bonus credits, jackpot symbols, and one or more symbol that replace other game symbols in the array. In one preferred form, said special symbols comprise different types of wild symbols. In another preferred form, said wild card symbols also confer one or more game enhancing elements to the player.

Preferably, said game enhancing elements comprise at least one or more of awarding a predetermined number of additional free spins, changing game symbols on the non-selected reels or adjacent to the special symbol into wild card symbols, trigger symbols to retrigger the feature game, held reels, randomly displaying wild card symbols, stacked symbols, bonus symbols, new game symbols, reveal symbols, progressive symbols, bonus credits, jackpot symbols, and one or more symbol replacements. In some embodiments, the game enhancing elements comprise at least one or more of a predetermined number of free games, an enhanced game, bonus prizes, collector symbols, a win multiplier, wild multipliers, bonus wilds, symbols that cause the award of additional free games, trigger symbols to retrigger the game or enhanced game, directly retriggering the game or enhanced game, held columns, random wild symbols, progressives, bonus credits, jackpot symbols, and one or more symbol replacements.

Preferably, the award of free games also triggers replacement of the game with the enhanced game, said enhanced game offering more types of game enhancing elements than said game. In one preferred form, said enhanced game modifies the free games played. More preferably, said game randomly awards one or more game enhancing elements that modify the result of each said free game.

Preferably, said array comprises said predetermined game positions arranged into rows and columns, and said groups comprise said columns of said array. Alternatively, said groups each comprise one of said predetermined game positions displayed on said display. In one preferred form, said array comprises said predetermined game positions arranged into rows and columns, and said groups comprise individual cells of each row and/or column.

Preferably, said trigger event is randomly determined by said electronic game controller. Alternatively, said trigger event is preferably a player-actuated trigger event. In one preferred form, said player-actuated event comprises a player actuating a group selection button on said display and/or electronic gaming machine.

Preferably, said game comprises a base game and a feature game, where said play comprises a play of said base game and said subsequent plays comprise plays of said feature game.

Preferably, the player selectively starts and/or stops play of said game.

Preferably, said electronic gaming machine comprises a housing and an input device. It is preferred that said input device comprises one or more buttons on said housing, said buttons being in electronic communication with said electronic game controller to transmit player commands to said electronic game controller. More preferably, said buttons are arranged on a console of said housing. Alternatively or additionally, said input device comprises a touch sensitive surface on said display for receiving player commands, said touch sensitive surface being in electronic communication with said electronic game controller to transmit player commands to said electronic game controller.

Preferably, said housing comprises a value transfer mechanism for paying said prizes to said player using value in an amount equal to an awarded prize. More preferably, said value transfer mechanism also receives value from said player to initiate said bet. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Preferably, the electronic gaming machine comprises a mobile electronic gaming device. More preferably, said mobile electronic gaming device comprises a handheld electronic device. In one preferred form, said handheld electronic device comprises a handheld electronic gaming device or a smart phone. Alternatively, said electronic gaming machine comprises a computer. More preferably, said computer is connected to a communication network.

According to a second aspect of the present invention, there is provided an electronic gaming machine comprising:

a housing having a display for displaying game symbols for playing a game and an electronic game controller in electronic communication with said display for controlling the appearance of game symbols in said game on the display, wherein said game comprises game symbols arranged into an array of groups of one or more predetermined game positions displaying randomly selected game symbols randomly displaying said game symbols and where predetermined winning combinations of said randomly selected game symbols in said game award prizes to a player; and

an input device for receiving commands from said player to operate said electronic gaming machine and initiate play of said game on said display, said input device being in electronic communication with said electronic game controller;

wherein said electronic game controller in response to a command from said player via said input device commences play of said game by randomly selecting game symbols and transmitting a signal to said display to display said randomly selected game symbols;

wherein in response to a trigger event occurring in a play of said game, said electronic game controller permits the player to select one or more of said groups of predetermined game positions and after said selection said electronic game controller transmits a signal to said display so that said selected groups randomly display one or more special symbols in one or more subsequent plays of said game so as to increase the probability of the electronic gaming machine displaying one of said predetermined winning combinations and/or award a game enhancing element upon the player.

The second aspect preferably has the preferred features of the first aspect of the invention stated above, where applicable.

According to a third aspect of the invention, there is provided a gaming method for an electronic gaming machine having a display and an electronic game controller, comprising:

controllably displaying game symbols on said display to play a game wherein predetermined winning combinations of randomly selected game symbols in said game award prizes to a player;

arranging said game symbols into an array of predetermined game positions displaying said game symbols;

in response to a trigger event occurring in a play of said game, enabling said player to select one or more of said groups of predetermined game positions, and

causing said selected groups to randomly display one or more special symbols in one or more subsequent plays of said game so as to increase the probability of the electronic gaming machine displaying one of said predetermined winning combinations and/or award one or more game enhancing elements.

Preferably, said method comprises determining the number of said subsequent plays of said game based on the groups selected by the player.

Preferably, said method comprises determining the type of special symbols displayed in said groups based on the groups selected by the player. More preferably, said special symbol determining step comprises selecting different types of wild card symbols.

Preferably, said method comprises awarding one or more game enhancing elements to said player based on the special symbols displayed in said subsequent plays of said game.

Preferably, said arranging step comprises arranging said predetermined game positions arranged into rows and columns, and said groups comprise said columns of said array. Alternatively, said groups comprise one of said predetermined game positions displayed on said display.

Preferably, the method comprises configuring said trigger event as a player-actuated trigger event.

The method also preferably has the preferred features of the first aspect of the invention stated above, where applicable.

According to a fourth aspect of the invention, there is provided a gaming method for an electronic gaming machine comprising a housing having a display for displaying a game, wherein said game comprises game symbols and predetermined winning combinations of randomly selected game symbols in said game award prizes to a player; an electronic game controller inside said housing for controlling the display of said game symbols for playing said game on said display; and an input device for receiving commands from said player to operate said electronic gaming machine, said input device being in electronic communication with said electronic game controller, the method comprising:

said electronic game controller receiving a command from said player via said input device to initiate play of said game on said display;

said electronic game controller transmitting a signal to said display to controllably display game symbols on said display to play a game wherein predetermined winning combinations of randomly selected game symbols in said game award prizes to a player;

said electronic game controller transmitting a signal to said display to arrange said game symbols into an array of predetermined game positions displaying said game symbols;

in response to a trigger event occurring in a play of said game, said electronic game controller enabling said player to select one or more of said groups of predetermined game positions, and

said electronic game controller transmitting a signal to said display so that said selected groups randomly display one or more special symbols in one or more subsequent plays of said game so as to increase the probability of the electronic gaming machine displaying one of said predetermined winning combinations and/or award one or more game enhancing elements.

This fourth aspect preferably has the preferred features of the third aspect of the invention stated above, where applicable.

According to a fifth aspect of the invention, there is provided a gaming system comprising a central processing unit configured for communication with an electronic gaming machine, wherein said gaming system is configured to perform the method of the third or fourth aspects of the invention on said electronic gaming machine.

According to a sixth aspect of the invention, there is provided a computer programme configured to perform the method of the third or fourth aspects of the invention.

According to a seventh aspect of the invention, there is provided a non-transitory carrier medium carrying computer executable code that, when executed on a central processing unit configured for communication with an electronic gaming machine, causes the central processing unit to perform the method of the third or fourth aspects of the invention on said electronic gaming machine.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to a first embodiment of the invention;

FIG. 2 is a schematic drawing of an electronic game controller for the electronic gaming machine of FIG. 1;

FIG. 3 is a front view of the display of the electronic gaming machine of FIG. 1 illustrating a base game;

FIG. 4 is a front view of the display of the electronic gaming machine of FIG. 1 illustrating the selection of reels, and

FIG. 5 is a front view of the display of the electronic gaming machine of FIG. 1 illustrating a feature game.

### DETAILED DESCRIPTION OF VARIOUS EMBODIMENTS

The present invention will now be described with reference to the following examples which should be considered in all respects as illustrative and non-restrictive.

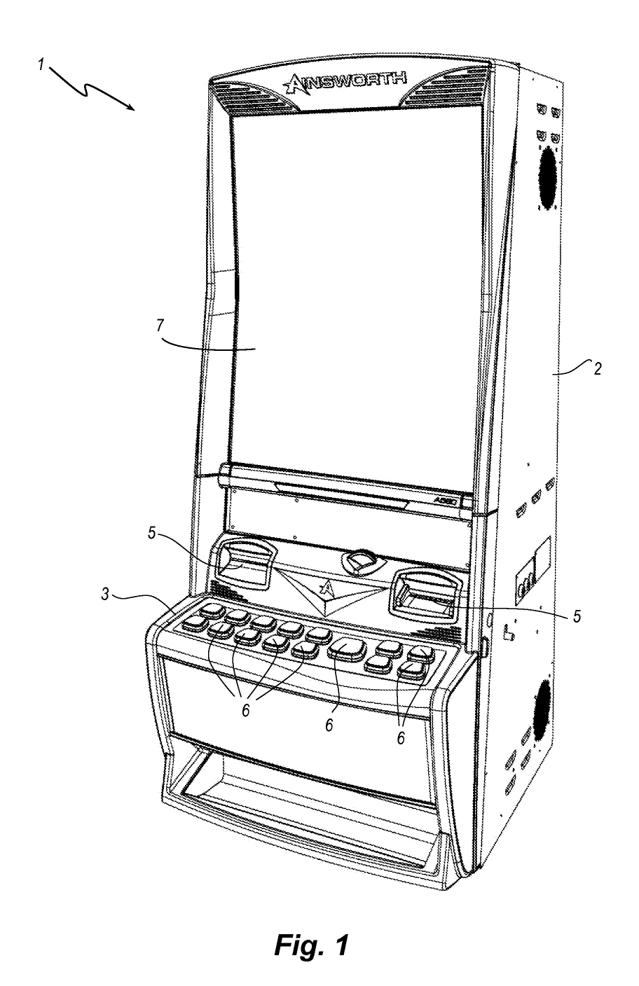

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

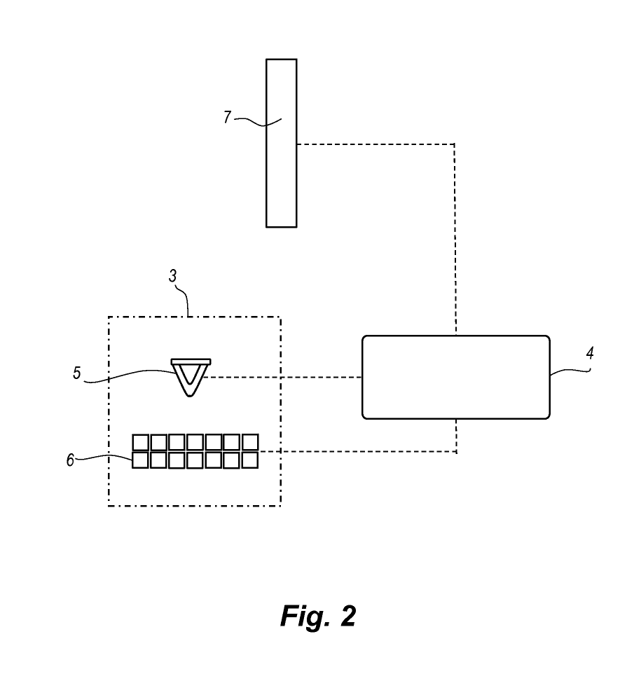

The electronic game controller 4 is generally in the form of a central processing unit, such as a computer, and is in electronic communication with a display 7 in the form of a video display screen, as well as various input devices on the console 3 as best shown in FIG. 2. Typically, the electronic game controller 4 also comprises a random access memory (RAM) associated with the central processing unit, the RAM being used to store programme instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1.

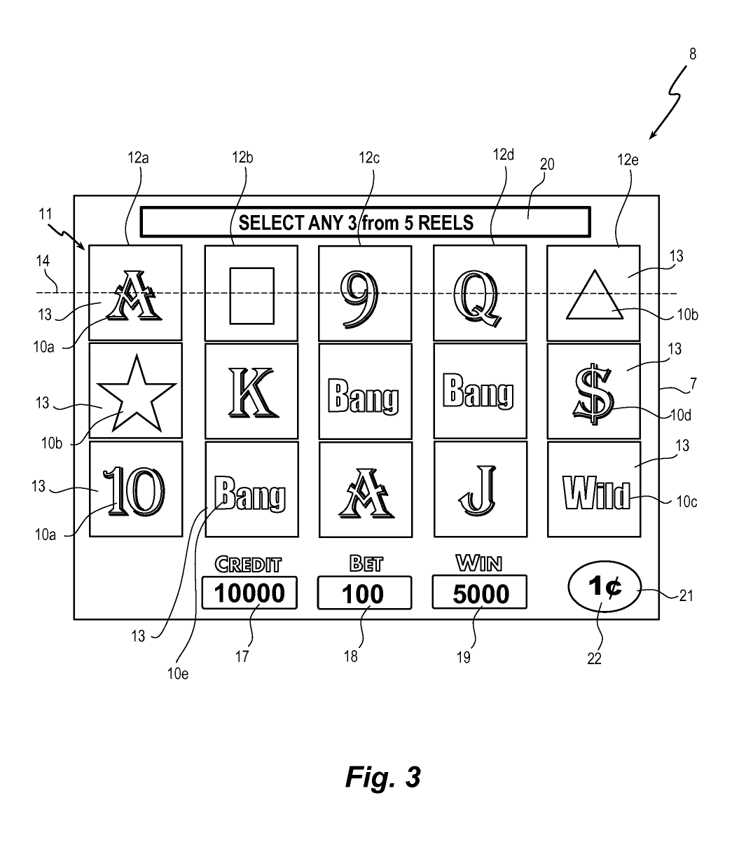

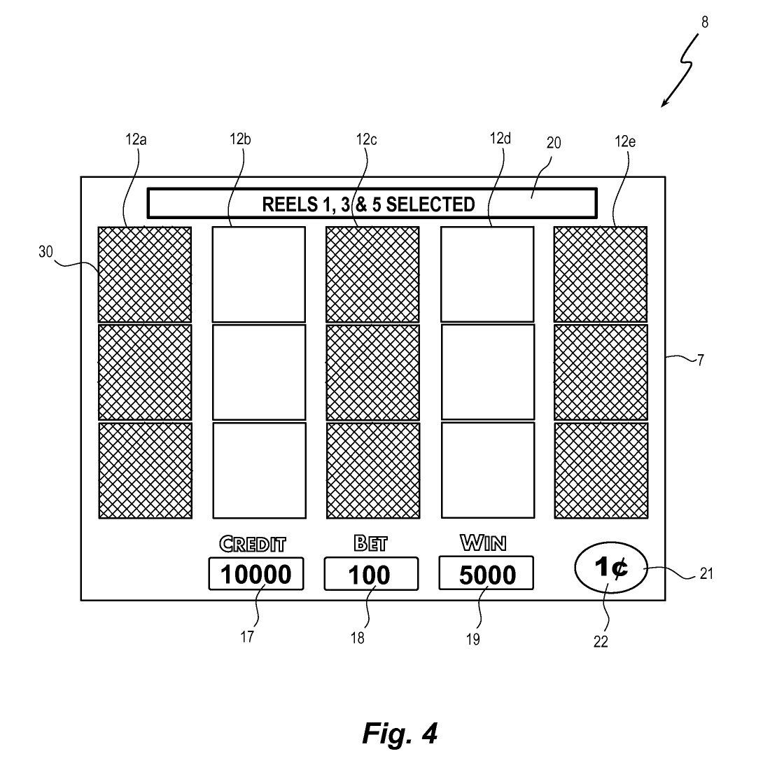

The electronic game controller 4 is programmed to provide a game in the form of a base game 8 (as best shown in FIG. 3) and a feature game 9 (as best shown in FIG. 4) on the electronic gaming machine 1 for play by a player. The base game 8 has game symbols 10 arranged into an array 11 in the form of five columns or “reels” 12, as best shown in FIG. 3. The reels 12 give the visual appearance of rotating, typically by having the game symbols 10 move in a downward linear path along the length of each reel 12. While the array 11 is arranged with five reels 12 and three rows as per the industry standard, it will be appreciated by one skilled in the art that other types of arrays could be used, such as 3×3, 4×3, 5×5, 4×4, etc., including arrays having an irregular number of rows and/or columns. For example, the array 11 can have an unequal number or rows and/or columns, where some columns have less or more rows than other columns or where some rows have less or more columns than other rows. A more specific example would be an array having three columns with only two rows and two columns with three rows. Another example would be an array having five reels of which two reels only have three rows while three reels have four rows. In some embodiments, the array 11 has an irregular shape. The electronic game controller 4 will transmit signals to the display screen 7 to cause the base game 8 and feature game to be played on the lower playing area 7a, including showing the game symbols 10, array 11 and other visible elements of the games

The array 11 of the base game 8 defines predetermined symbol positions 13 in which the game symbols 10 appear. The symbol positions 13 are defined by visible boundary lines (to define “squares” or cells 13). However, it will be appreciated that in other embodiments, the symbol positions 13 are not visually marked by boundary lines and simply provide an area for the game symbols 10 to appear. In some embodiments, other markings are used to define each respective area of the symbol positions 13. The array 11 is arranged so that a player can select one or more predetermined “pay lines” 14 defined around the array, which correspond to combinations of the symbol or game positions 13. The pay lines 14 correspond to the lines selected by the player and generally comprise at least one symbol or game position 13 from each reel 12. The number of pay lines 14 that can be selected by the player depends on the amount of the monetary bet for playing a game on the array 11. In the base game 8, predetermined winning combinations of randomly selected game symbols 10 appearing on the same pay line 14 result in the award of prizes to the player. In the feature game 9, predetermined winning combinations of randomly selected game symbols 10 also result in the award of prizes to the player, usually of an enhanced value compared to the prizes awarded in the base game 8.

The game symbols 10 can include a mixture of picture symbols (such as animal symbols or playing card symbols), word symbols, scatter symbols, substitute or wild card symbols and trigger symbols to trigger the feature game 9. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In this embodiment, the game symbols 10 include playing card symbols 10a, item-themed or picture symbols 10b, substitute or wild card symbols in the form of “WILD” symbols 10c, a scatter symbol in the form of a $ symbol 10d and a trigger symbol in the form of a “BANG” symbol 10e. The electronic game controller 4 randomly determines the appearance of the game symbols 10 on the array 11.

The video screen 7 also displays standard game information including the amount of player credits 17, the amount of the current bet wagered by the player 18, the amount of wins by the player 19, a message area 20, and a current denomination button 21 indicating the currently selected base bet denomination 22. Other standard game information that can be displayed includes the number of pay lines available and the number of player-selected pay lines.

In the base game 8, the player initially makes a bet using vending slots 5 initiate play of the electronic gaming machine 1 to build up credit to play the base game on the electronic gaming machine. The player can bet or wager monetary amounts equivalent to a particular amount of credits, depending on the bet denomination selected for the base game. For example, the player can bet or wager 50 credits to play 10 pay lines or 200 credits to play 50 pay lines. Also, the player can make any additional side bets or ante-bets to access additional features in the base game 8, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc. The electronic gaming machine 1 also offers a variety of bet denominations of 1¢, 2¢, 5¢ and 10¢ for the base game 8.

Typically, the electronic gaming machine 1 has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game 8, which would be the 1¢ bet denomination for this embodiment. The player may change the bet denomination at any time in the base game 8 by touching the denomination button before or after the reels 12 have spun.

The electronic game controller 4 then transmits a signal to the display 7 so as to cause the reels 12 to appear to visibly rotate or “spin” in a linear path, typically in a downward vertical direction, and randomly display the game symbols 10 in each symbol position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

The electronic game controller 4 also randomly determines whether a predetermined trigger event has occurred which triggers the feature game 9 on the electronic gaming machine 1. In this embodiment, the trigger event is the appearance of three BANG trigger symbols 10e anywhere on the reels 12 without having to be on a player-selected pay line 14, as best shown in FIG. 3. As a precursor to playing the feature game 9, and upon the occurrence of the trigger event, the player is asked to select three of the five reels 12a to 12e in the message area 20, as best shown in FIG. 4.

Once the player makes a selection of three of the reels 12, the selected reels are then highlighted, as indicated by reference numeral 30 and shown in FIG. 4. This highlighting 30 can be shown to the player in various ways, such as using a brightly lit border around each selected reel, increasing the brightness of the selected reels compared to the other reels, increasing the size of the selected reels relative to the non-selected reels, shading the selected reels differently to the non-selected reels and superimposing a translucent image over the selected reels.

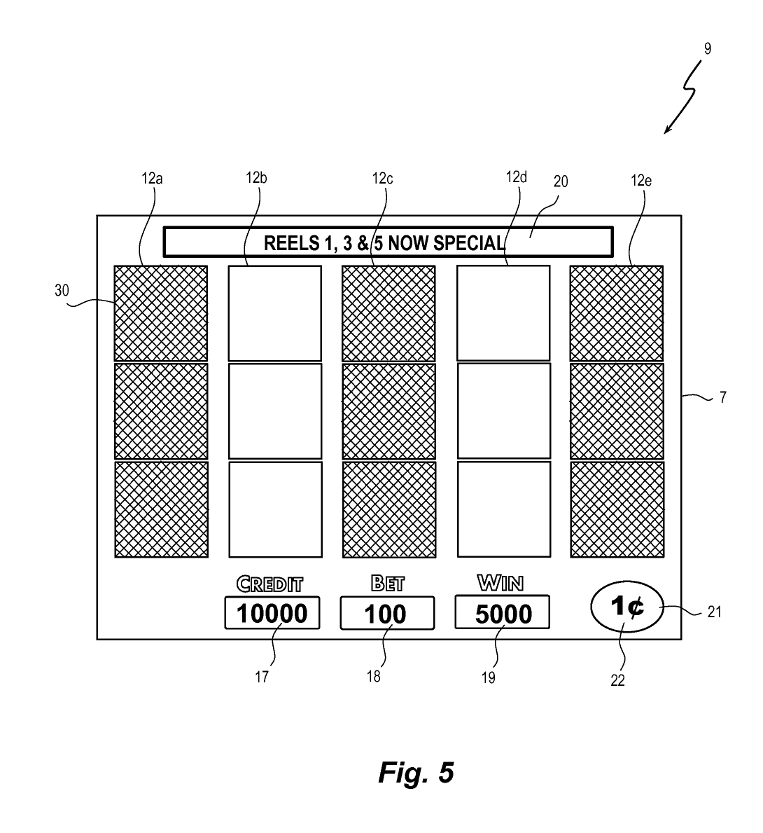

After the player's selection of the reels 12, the electronic game controller 4 then transmits a signal to the display screen 7 to cause the feature game 9 to be shown on the screen 7, as best shown in FIG. 5. In the feature game 9, the selected reels (being reels 12a, 12c and 12e in the illustrated embodiment) continued to be highlighted as indicated by reference numeral 30. The message area 20 also indicates that the selected reels 12a, 12c and 12e have been selected by stating that they are “special”.

In the feature game 9, a predetermined number of free plays or spins of the feature game are awarded to the player. It will be understood by those skilled in the art that a free spin involves a play of the game without requiring any bet to be made by the player, and that any number of free spins can be chosen for the feature game. In addition, it will be appreciated that in the art free spins are commonly referred to as “free games”. In this case, the reels 12 in the feature game 9 are spun without requiring the player to make a bet, unlike the base game 8.

The selected reels 12 can be configured to operate in different ways and thus provide a variety of effects. In this embodiment, the reels 12 that are selected determine the number of free spins or plays of the feature game 9 that is awarded to the player. For example, the player's selection of reels 12a, 12c and 12e in this embodiment results in an award of fifteen free spins of the feature game 9. However, if reels 12b, 12c and 12d are selected that the player only receives nine free spins of the feature game 9, but as compensation for having less free spins the selected reels 12b, 12c and 12d have a higher probability of displaying WILD symbol 10c. Thus, the player can opt to either have a higher number of free spins and a base level of probability of achieving a winning combination or a lower number of free spins with a higher probability of achieving a winning combination via the increased probability of WILD symbol 10c. This is achieved using different reel strips for the selected reels to the reel strips used for the non-selected reels (and the reels strips for the reels in the base game 8) so that there is a higher proportion of WILD symbols 10c on the selected reels compared to number of WILD symbols on the non-selected reels. As there are various combinations of three reels, there is a continuum from a lower number of free spins and an increased probability of wins to a higher number of free spins and a decreased probability of wins. This gradual change between these two extremes enables player to select their comfort level of balancing risk and reward in the feature game 9. Thus, this ability for the player to customise or tailor the risk and reward ratio in the feature game 9 increases player interest and excitement in continually playing the electronic gaming machine 1.

In another embodiment, the same number of free spins of the feature game 9 is awarded to the player irrespective of the specific reels 12 that are selected. Instead the selected reels 12a, 12c and 12e display wild card symbols that do not appear in the base game 8 and provide additional game enhancing elements not otherwise available in the base game. For example, the selected reels may display bonus or multiplier wild card symbols that increase the value of any prizes awarded for winning combinations that use any of the bonus wild card symbols, either by a set amount (such as adding 50 credits to any award prize) or as a multiple (such as multiplying any award prize in value by 2, 3 or 5). This is also achieved by using different reel strips for the selected reels compared to reel strips used for the non-selected reels and the reels in the base game 8. The ability of the player to access different wild card symbols to increase the value of any awarded prizes enhances player interest and excitement in continually playing the electronic gaming machine 1.

In some embodiments, the selected reels display special symbols that confer other types of game enhancing elements. The game enhancing elements may comprise awarding a predetermined number of additional free spins, changing game symbols on the non-selected reels or adjacent to the special symbol into wild card symbols, trigger symbols to retrigger the feature game, held reels (i.e. reels that constantly display card wild symbols), randomly displaying wild card symbols, stacked symbols, bonus symbols, new game symbols, reveal symbols, progressive symbols, bonus credits, jackpot symbols, and one or more symbol replacements. Again, this is achieved by using different reel strips for the selected reels compared to reel strips used for the non-selected reels and the reels in the base game 8. In a further variation, in some embodiments, the reel selected by the player determines which of the game enhancing elements become available to the player. For example, if the player selects reel 12a, then this reel will show symbols that awards additional free spins, whereas if the player selects reel 12b, this reel will show symbols that change game symbols in the cells of the non-selected reels adjacent to that symbol into wild card symbols. Moreover, the game enhancing elements are preferably exclusive to that reel. Thus, the player is able to “mix and match” the game enhancing elements that can be awarded in the feature game 9. Thus, the player is able to customise the game enhancing elements that he or she prefers by selecting the appropriate reel. This increases player engagement with the game and thus the player is more likely to continue playing on the same electronic gaming machine 1. Also, the ability of the player to access different game enhancing elements not otherwise accessible in the base game 8 enhances player interest and excitement in continually playing the electronic gaming machine 1.

In the above described embodiments, differently selected reels may have different probabilities of achieving wild card symbols, multiplier symbols or special symbols depending upon the location of the selected reels in the array 11.

In any event, the selected and non-selected reels 12 then spin for a play of the feature game 9, and when the reels stop the electronic game controller 4 determines whether any winning combinations of the game symbols randomly displayed on each symbol position 13 appear on the player-selected pay lines 14. Where the selected reels 12a, 12c, 12e display new wild card symbols or confer game enhancing elements as discussed above, the electronic game controller 4 also determines whether there the player is to be awarded the benefit of those new wild card symbols or game enhancing elements.

In one preferred form, the electronic game controller 4 internally determines whether to trigger or activate the feature game 9 (and hence the selection of the reels 12) instead of using the random display of three $ trigger symbols 10d. In another embodiment, the electronic game controller 4 generates an internal trigger event, such as randomly generating a number between 1 and 10, and activating the feature game 9 (and hence the selection of the reels 12) if the randomly generated number is in the range of 1 to 4. In an alternative preferred form, the electronic game controller 4 causes triggering of the feature game 9 (and hence the selection of the reels 12) automatically after each play of the base game 8.

In yet another alternative, the trigger event is a player-actuated event, which can be implemented by using appropriate touch-screen buttons on the display 7 and/or physical buttons 6 on the console 3. The player-actuated trigger event can either be for the feature game 9 (and hence the selection of the reels 12) or for the selection of the reels 12 separate to a trigger event for the feature game 9. In this latter case, the electronic gaming controller 4 still determines activation of the feature game 9, but the player determines whether or not to activate the selection of the reels 12 in the feature game. In a further preferred form, there are separate player-actuated trigger events for both the feature game 9 and the selection of the reels 12.

In each of these preferred forms, it is contemplated that the player would make an ante bet in addition to his or her bet to play the base game 8 to access the ability to activate the feature game 9 and/or the selection of the reels 12. Thus, an ante bet may be made to access the ability to activate the feature game 9 at any time, and the same ante bet or an additional ante bet enables access to the selection of the reels 12. This can result in a “standard” feature game (not requiring an ante bet but randomly triggered), an enhanced feature game (in that the feature game is player activated) and a further improved feature game having the selection of the reels (the feature game 9 and/or reel selection is player activated). The enhanced and improved feature games would require an ante bet (more than one ante bet) to be made to access these versions of the feature game. It is also contemplated that where there is no feature game but only a “base” game, the ante bet enables the player to access the selection of the reels 12 as an enhancement to the game.

While the preferred embodiment has been described using selectable reels comprising columns in an array of rows and columns, it will be appreciated that the invention can equally applied to reels that comprise a single cell, the reels being arranged in an array of rows and/or columns of individual reels. For example, in a 5×3 array, there would be fifteen reels instead of five reels.

In other preferred forms, the base game 8 and feature game 9 need not be displayed on a single video screen 7. Instead, they may be displayed on separate video screens, with the reels 12 of the array 11 for the base game 8 appearing in a lower video screen and a duplicate set of reels of the array for the feature game 9 appearing on an upper video screen. In other embodiments, the order can be reversed, with the array 11 for the base game 8 appearing on an upper video screen or upper part of a single video display screen 7 and the feature game 9 (or standard game information) appearing on a lower video screen or lower part of a single video display screen.

In another preferred form, the video screen 7 is a touch screen for use in addition to the player-actuatable buttons 5 so as to enable the player to select various features, such as making monetary bets for the base game, initiating play of the base and feature games played and responding to any messages or requests issued on the electronic gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a symbol may appear in the reel 12.

In other preferred forms, a jackpot prize is also offered as part of the base game 8 on the electronic gaming machine 1 and can be shared with any other games offered on the electronic gaming machine (as in multi-game gaming machines) or games offered on separate electronic gaming machines (typically controlled via a central jackpot controller). There also may be a plurality of jackpot prizes offered.

The jackpot prize(s) may include progressive jackpots, fixed jackpots and mystery jackpots. A progressive jackpot prize takes a portion of each bet (typically a set percentage of each bet) made on the electronic gaming machine and thus the amount of the progressive jackpot incrementally increases as more bets are made on the electronic gaming machine 1. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together. During play of the base game 8 and/or feature game 9 the electronic game controller will determine whether a trigger event for any of the selected jackpots has occurred, as described above. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, their values are reset and game play of the electronic gaming machine 1 continues as before. The values of the jackpots that have been won can be reset either to a predetermined start value or simply increment upwardly from zero where the won jackpot is a progressive jackpot. In addition, contributions of portions of the bet made to play the game are only made for the selected jackpots that are active. In this way, the player's bets do not contribute towards jackpots that the player cannot win.

In one preferred form, the jackpot prize comprises a mystery jackpot. That is, none of the symbols in the game trigger the jackpot; hence the triggering event is a “mystery”. By way of comparison, a standard jackpot is typically symbol driven in that a particular combination of symbols must occur in the game to trigger the standard jackpot. The trigger event for the mystery jackpot can be one randomly generated by the electronic game controller 4 for each play of the game 8. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the mystery jackpot, which could also be a progressive jackpot prize. It will be appreciated that this manner of determining the trigger event may also be used to determine whether the feature game 9 is triggered in the base game 8.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to any jackpot prizes won on the electronic gaming machine 1.

In some embodiments, the types of game enhancing elements include fixed monetary prizes, “Held Reels”, “×10 Multiplier” (applicable to the prize awarded by the base game for the five of a kind trigger combination and/or to the total amount of the bet or credits bet per pay line), “10 Free Spins/Games”, progressive symbols and changing the function of a standard game symbol 10a, 10b into a substitute symbol in addition to any displayed substitute Dragon symbols 10c. Held columns or reels typically involve the column or reel to only display wild/substitute symbols, thus enhancing the probability of achieving a predetermined combination. Progressive symbols award a prize is awarded upon a certain number of progressive symbols are accumulated by the player over a number of games played on the gaming machine. Other examples include:
i) symbols that award a predetermined number of free plays of said game, such as 8, 10 or 15 free spins or games;
ii) win multiplier symbols that multiply the amount of any win from one of said predetermined winning combinations;
iii) “wild” symbols that cause the display of substitute symbols in randomly selected symbol positions;
iv) bonus symbols that awards a bonus prize, either as a monetary amount or as a bonus credit;
v) wild multiplier symbols that cause the display of substitute symbols on the array 11 and multiplies the amount of any win from one of said predetermined winning combinations;
vi) bonus wild symbols that cause the display of substitute symbols on the array 11 and awards a bonus prize;
vii) symbols that cause the award of additional free plays of said game;
viii) symbols that cause one or more of said symbol positions to be held static (typically one or more reels 12a to 12e) and display substitute symbols on the array 11;
ix) symbols that cause the same game symbol to be stacked in a group of symbol positions, typically the group being one or more reels 12a to 12e;
x) symbols that cause the display of new game symbols on the array 11;
xi) “reveal” symbols that cause a game symbol to reveal another game symbol;
xii) “replacement” symbols that cause one or more game symbols to be replaced by other game symbols in the array 11;
xiii) bonus prizes of 5× bet, 10× bet or 25× bet (the total amount of the bet or credits bet per pay line);
xiv) all royal card symbols change to wilds (substitute symbols) on reels 2, 3 and 4 (i.e. reels 12b, 12c and 12d) of the array 11;
xv) all picture symbols change to wilds on reels 2, 3 and 4 (i.e. reels 12b, 12c and 12d) of the array 11;
xvi) all symbols on reels 2 and 4 (i.e. reels 12b and 12d) of the array 11 change to wild symbols; and
xvii) all symbols on reels 1 and 5 (i.e. reels 12a and 12e) of the array 11 change to wild symbols.

These game enhancing symbols do not modify the function or value of the game symbols 10 that appear on the array 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

In other preferred embodiments, additional game enhancing symbols include the award of points or tokens that lead to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

While the same game format can be essentially used across the base game 8 and feature game 9, it will be appreciated that the game format may vary across both the base game and feature game. For example, the feature game 9 could adopt a different format of cells and/or use an entirely different set of game symbols, or a mixture of game symbols from the base game and different game symbols. In another example, the base game may be a wheel-type game or a four reel game and the feature game may be a standard five reel game. Similarly, the base game 8 and feature game 9 may each have different game symbols, game rules and pay tables that are unique to each game. Also, the arrangement of the base game 8 and the feature game 9 is not limited to a set of reels or columns, but could take other forms, such as non-rectangular arrays (i.e. arrays that do not comprise rows and columns). For example, where the array is circular, the predetermined game positions can take the form of pie-shaped slices or wedges.

In some embodiments, the electronic gaming machine 1 comprises a housing and an input device. The input device comprises one or more buttons 6 on the housing, the buttons being in electronic communication with the electronic game controller 4 to transmit player commands to the electronic game controller. In some embodiments, the buttons 6 need not be arranged on the console 3. Alternatively or additionally, the input device comprises a touch sensitive surface on the display 7 for receiving player commands, the touch sensitive surface being in electronic communication with the electronic game controller 4 to transmit player commands to the electronic game controller. The housing may also comprise in some embodiments a value transfer mechanism for paying the prizes to the player using value in an amount equal to an awarded prize. More preferably, the value transfer mechanism also receives value from the player to initiate the bet.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer programme configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of selected reels conferring game enhancing elements and the feature of selected reels providing different number of free spins can be combined into the same feature game of the electronic gaming machine 1. Similar combinations of two or more features from the above described embodiments or preferred forms of the invention can be readily made by one skilled in the art.

By providing selectable reels that substantially affect the value and/or types of prizes awarded in a game, the invention introduces a variety in game play and game mechanics for a player, thus increasing the player's excitement and retaining his or her interest in playing the same electronic gaming machine. Also, in one embodiment by further providing a variable number of free spins and variable probability of winning combinations based on the reels selected by a player, the invention further increases the player's interest and participation in the electronic gaming machine. The invention also adds greater value to a player in terms of the probability of winning a prize and providing greater variety in game play, especially compared to a conventional electronic gaming machine. All these advantages of the invention result in the player being more likely to retain interest in continuing to play the same electronic gaming machine due to the variation in game play on the electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a housing having a display for displaying game symbols for playing a game and an electronic game controller in electronic communication with said display for controlling the appearance of game symbols in said game on the display, wherein said game comprises game symbols arranged into an array of groups of one or more predetermined game positions displaying randomly selected game symbols, and where predetermined winning combinations of said randomly selected game symbols in said game award prizes to a player; and
an input device for receiving commands from said player to operate said electronic gaming machine and initiate play of said game on said display, said input device being in electronic communication with said electronic game controller;
wherein said electronic game controller in response to a command from said player via said input device commences play of said game by randomly selecting game symbols and transmitting a signal to said display to display said randomly selected game symbols;
wherein in response to a trigger event occurring in a play of said game, said electronic game controller permits the player to select one or more of said groups of one or more predetermined game positions and after said selection said electronic game controller transmits a signal to said display so that said selected groups randomly display one or more special symbols in one or more subsequent plays of said game so as to increase the probability of the electronic gaming machine displaying one of said predetermined winning combinations and/or award a game enhancing element upon the player.

2. The electronic gaming machine of claim 1, wherein the groups selected by the player determine the number of said subsequent plays of said game.

3. The electronic gaming machine of claim 1, wherein the groups selected by the player determine the type of special symbols displayed in said groups

4. The electronic gaming machine of claim 3, wherein said special symbols comprise different types of wild card symbols.

5. The electronic gaming machine of claim 1, wherein said special symbols award one or more game enhancing elements to said player.

6. The electronic gaming machine of claim 5, wherein said game enhancing elements comprise at least one or more of awarding a predetermined number of additional free spins, changing game symbols on the non-selected reels or adjacent to the special symbol into wild card symbols, trigger symbols to retrigger the feature game, held reels, randomly displaying wild card symbols, stacked symbols, bonus symbols, new game symbols, reveal symbols, progressive symbols, bonus credits, jackpot symbols, and one or more symbol replacements.

7. The electronic gaming machine of claim 1, wherein said array comprises said predetermined game positions arranged into rows and columns, and said groups comprise said columns of said array.

8. The electronic gaming machine of claim 1, wherein said groups each comprise one of said predetermined game positions displayed on said display.

9. The electronic gaming machine of claim 1, wherein said trigger event comprises a player-actuated trigger event.

10. The electronic gaming machine of claim 1, wherein said game comprises a base game and a feature game, where said play comprises a play of said base game and said subsequent plays comprise plays of said feature game.

11. A gaming method for an electronic gaming machine comprising a housing having a display for displaying a game, wherein said game comprises game symbols and predetermined winning combinations of randomly selected game symbols in said game award prizes to a player; an electronic game controller inside said housing for controlling the display of said game symbols for playing said game on said display; and an input device for receiving commands from said player to operate said electronic gaming machine, said input device being in electronic communication with said electronic game controller, the method, comprising:
said electronic game controller receiving a command from said player via said input device to initiate play of said game on said display;
said electronic game controller transmitting a signal to said display to controllably display game symbols on said display to play a game wherein predetermined winning combinations of randomly selected game symbols in said game award prizes to a player;
said electronic game controller transmitting a signal to said display to arrange said game symbols into an array of predetermined game positions displaying said game symbols;
in response to a trigger event occurring in a play of said game, said electronic game controller enabling said player to select one or more of said groups of one or more predetermined game positions, and
said electronic game controller transmitting a signal to said display so that said selected groups randomly display one or more special symbols in one or more subsequent plays of said game so as to increase the probability of the electronic gaming machine displaying one of said predetermined winning combinations and/or award one or more game enhancing elements.

12. The gaming method of claim 11, comprising determining the number of said subsequent plays of said game based on the groups selected by the player.

13. The gaming method of claim 11, comprising determining the type of special symbols displayed in said groups based on the groups selected by the player.

14. The gaming method of claim 13, wherein said special symbol determining step comprises selecting different types of wild card symbols.

15. The gaming method of claim 11, comprising awarding one or more game enhancing elements to said player based on the special symbols displayed in said subsequent plays of said game.

16. The gaming method of claim 11, wherein said arranging step comprises arranging said predetermined game positions arranged into rows and columns, and said groups comprise said columns of said array.

17. The gaming method of claim 11, wherein said groups comprise one of said predetermined game positions displayed on said display.

18. The gaming method of claim 11, comprising configuring said trigger event as a player-actuated trigger event.

19. The gaming method of claim 11, wherein said game comprises a base game and a feature game, and said play comprises a play of said base game and said subsequent plays comprise plays of said feature game.
